(19) United States
(12) Patent Application Publication
(10) Pub. No.: US 2010/0173818 A1
(43) Pub. Date: Jul. 8, 2010

(54) CATIONIC POLYMER-CONTAINING SOLID COMPOSITION AND METHOD

(76) Inventors: Ditmar Kischkel, Monheim (DE); Manfred Weuthen, Langenfeld (DE); Rolf Wachter, Dusseldorf (DE); Rainer Eskuchen, Langenfeld (DE)

Correspondence Address: FOX ROTHSCHILD LLP, 997 Lenox Drive, Bldg. #3, Lawrenceville, NJ, 08648, US

(21) Appl. No.: 12/063,694

(22) PCT Filed: Aug. 8, 2006
(86) PCT No.: PCT/EP06/07815

§ 371 Date: Feb. 13, 2008

(30) Foreign Application Priority Data
Aug. 17, 2005 (DE) 10 2005 039 168.0

(51) Int. Cl. C11D 3/37; C11D 1/29

(52) U.S. Cl. 510/351; 510/276

(57) ABSTRACT

A solid composition including 0.1 to 99% by weight of a cationic polymer having dye-transfer-inhibiting and/or dye-fixing properties and 99.9 to 1% by weight of an anionic surfactant is provided. A composition including (a) 0.1 to 99% by weight polydiallyl dialkyl ammonium compounds; (b) 1 to 90% by weight anionic surfactants; (c) 0 to 20% by weight soap; and (d) 0 to 35% by weight nonionic surfactants is also provided. A method for the preparation of solid detergents includes combining 0.1 to 99% by weight of a cationic polymer having dye-transfer-inhibiting and/or dye-fixing properties and 99.9 to 1% by weight of an anionic surfactant, and adding to a detergent.

### CROSS-REFERENCE TO RELATED APPLICATIONS

This application is a national phase filing under 35 U.S.C. §371 and claims priority to International Application No. PCT/EP20061007815 which has an International filing date of Aug. 8, 2006, which designated the United States of America and which claims priority to German Application No. 10 2005039768.0, which was filed on Aug. 17, 2005, the entire disclosures of which are hereby incorporated herein by reference.

### BACKGROUND OF THE INVENTION

1. Field of the Invention

This invention relates generally to solid compositions containing cationic polymers, and more particularly, solid compositions containing cationic polymers with dye-fixing or dye-transfer-inhibiting properties in admixture with anionic surfactants and to their use in detergents.

2. Background Information

Color detergents are an independent product category in the detergent market. They are distinguished from conventional detergents by particular color protection of the washing. The transfer of dye from one article of clothing to another is reduced or prevented by so-called dye transfer inhibitors. Conventional transfer inhibitors, such as polyvinyl pyrrolidone (PVP) and derivatives thereof, such as PVP N oxides or PVP betaines for example, are known.

In addition, cationic polymers are known from the patent literature as dye transfer inhibitors and as dye fixers in detergents and fabric care compositions. Thus, WO 03/057815 A1 discloses a solid composition consisting of 1 to 90% by weight of a water-soluble dye-fixing agent and 2 to 80% by weight of a carrier. Carriers are understood to be inorganic ingredients typically in detergents. However, salt-form surfactants are excluded as carriers. WO 03/057815 also mentions cationic polymers, particularly polydiallyl dialkyl ammonium chlorides, as suitable dye fixing agents. The technical problem addressed in this patent was to overcome the incompatibility between cationic dye-fixing agents and anionic surfactants. As a solution, WO 03/057815 describes introducing the cationic polymer in the form of granules into a detergent formulation which already contains the anionic surfactant.

### SUMMARY OF THE INVENTION

Briefly described, according to an aspect of the invention, a solid composition includes (a) 0.1 to 99% by weight of a cationic polymer having dye-transfer-inhibiting and/or dye-fixing properties; and (b) 99.9 to 1% by weight of an anionic surfactant.

According to another aspect of the invention, a composition includes (a) 0.1 to 99% by weight polydiallyl dialkyl ammonium compounds; (b) 1 to 90% by weight anionic surfactants; (c) 0 to 20% by weight soap; and (d) 0 to 35% by weight nonionic surfactants.

According to another aspect of the invention, a method for the preparation of solid detergents includes combining 0.1 to 99% by weight of a cationic polymer having dye-transfer-inhibiting and/or dye-fixing properties and 99.9 to 1% by weight of an anionic surfactant, and adding to a detergent.

### DETAILED DESCRIPTION OF THE INVENTION

The problem addressed by the present invention was to formulate the cationic polymers together with anionic surfactants in order in this way to obtain readily processable compounds of dye transfer inhibitors and anionic surfactants for use in detergents.

It has been discovered that anionic surfactants can be formulated together with certain cationic polymers in a stable manner. It has surprisingly been found that the combination of anionic surfactants with dye-transfer-inhibiting cationic polymers can lead to a synergistic increase in the effect of the transfer inhibitors. In addition, it has been observed that the addition of certain nonionic surfactants can further enhance the effect.

Accordingly, the present invention relates to solid compositions containing:
a) 0.1 to 99% by weight of a cationic polymer having dye-transfer-inhibiting and/or dye-fixing properties,
b) 99.9 to 1% by weight of an anionic surfactant and,
c) optionally, other ingredients.

The compositions according to the invention are, without exception, solid, and are preferably present as powders or granules. Their percentage water content is below 10% by weight, preferably below 8% by weight, more preferably below 5% by weight and most preferably below 1% by weight. Typical ranges are, for example, 0.1 to 10% by weight and preferably 0.1 to 8% by weight or 0.1 to 5% by weight water. Compositions which contain no water are particularly preferred. In another preferred embodiment, the compositions only contain water emanating from the raw materials, if any water at all.

The compositions according to the invention contain a combination of cationic polymers having dye-transfer-inhibiting and/or dye-fixing properties and anionic surfactants.

The polymers a) are preferably water-soluble. Polydiallyl dialkyl ammonium chloride is preferably selected as component a). Polydiallyl dimethyl ammonium chloride or derivatives thereof are particularly preferred. Polymers selected in particular are those which have a molecular weight in the range from 1,000 to 1,000,000, more particularly in the range from 1,000 to 100,000 and, in a particularly preferred embodiment, in the range from 2,000 to 20,000. Polydiallyl dialkyl ammonium compounds suitable for the purposes of the present invention are known and commercially obtainable. The alkyl groups in these polymers may contain 1 to 18 carbon atoms and preferably contain 1 to 4 carbon atoms. Polydiallyl dimethyl ammonium chloride is particularly preferred. They are marketed, for example, under the names of TINOFIX FRD® and LUPASOL®. Such products preferably have Brookfield viscosities of 200 to 400 mPas. Their active substance (AS) content is typically up to 30-50%. Besides the salts, the copolymers of polydiallyl dimethyl ammonium, more particularly copolymers with acrylic acid, methacrylic acid, acrylamides or vinyl pyrrolidones, may also be used in principle for the purposes of the teaching according to the invention. In a preferred embodiment, the cationic polymers and preferably the polydiallyl dimethyl ammonium chloride or derivatives thereof may be used in freeze-dried form for the purposes of the invention.

Besides the polydiallyl dimethyl ammonium compounds, the compositions according to the invention also contain anionic surfactants as component b). Typical examples of anionic surfactants are, alkyl benzenesulfonates, alkanesulfonates, olefin sulfonates, alkylether sulfonates, glycerol ether sulfonates, α-methyl ester sulfonates, sulfofatty acids, alkyl sulfates, glycerol ether sulfates, fatty acid ether sulfates, hydroxy mixed ether sulfates, monoglyceride (ether) sulfates, fatty acid amide (ether) sulfates, mono- and dialkyl sulfosuccinates, mono- and dialkyl sulfosuccinamates, sulfotriglycerides, amide soaps, ether carboxylic acids and salts thereof, fatty acid isethionates, fatty acid sarcosinates, fatty acid taurides, N-acylamino acids such as, for example, acyl lactylates, acyl tartrates, acyl glutamates and acyl aspartates, alkyl oligoglucoside side sulfates, protein fatty acid condensates (particularly wheat-based vegetable products) and alkyl (ether) phosphates. If the anionic surfactants contain polyglycol ether chains, they may have a conventional homolog distribution although they preferably have a narrow-range homolog distribution.

Alkyl and/or alkenyl ether sulfates are preferably selected. Alkyl and/or alkenyl ether sulfates suitable for used as component (b) are known and industrially obtainable sulfation products of linear fatty alcohols or partly branched oxo alcohols. They preferably correspond to formula (I):

RO(CH₂CH₂O)ₙSO₃X (I)

in which R is a linear or branched alkyl and/or alkenyl group containing 6 to 22 carbon atoms, m is a number of 1 to 10 and X is an alkali metal and/or alkaline earth metal, ammonium, alkylammonium, alkanolammonium or glucammonium. Ether sulfates of the type mentioned are industrially produced by sulfation and subsequent neutralization of the corresponding alcohol polyglycol ethers. Typical examples are the sulfates based on addition products of on average 1 to 10 and, more particularly, 2 to 5 mol ethylene oxide onto caproic alcohol, caprylic alcohol, 2-ethyl hexyl alcohol, capric alcohol, lauryl alcohol, isotridecyl alcohol, myristyl alcohol, cetyl alcohol, palmitoleyl alcohol, stearyl alcohol, isostearyl alcohol, oleyl alcohol, elaidyl alcohol, petroselinyl alcohol, linolyl alcohol, linolenyl alcohol, elaeostearyl alcohol, arachyl alcohol, gadoleyl alcohol, behenyl alcohol, erucyl alcohol and brassidyl alcohol and technical mixtures thereof in the form of their sodium, potassium or magnesium salts, although mono- or triethanolamine cations are also suitable.

Another class of preferred anionic surfactants are the alkyl benzene sulfonates (ABS). These anionic surfactants preferably correspond to the formula R′-Ph-SO₃X, in which R′ is a branched, but preferably linear alkyl group containing 10 to 18 carbon atoms, Ph is a phenyl group and X is an alkali metal and/or alkaline earth metal, ammonium, alkyl ammonium, alkanolammonium or glucammonium. Dodecyl benzene sulfonates, tetradecyl benzene sulfonates, hexadecyl benzene sultanates and technical mixtures thereof in the form of the sodium salts are preferably used.

Besides the alkyl and/or alkenyl ether sulfates or ABS preferably used, soaps, preferably sodium and potassium soaps, may also be present as anionic surfactants—component c)—in the compositions according to the invention. Ethanolamine salts of the soaps are also suitable. The soaps are used in quantities of 1 to 45% by weight, preferably in quantities of 1 to 40% by weight, more preferably in quantities of 30% by weight and most preferably in quantities of up to 15% by weight. The potassium soaps and particularly the sodium soaps of C₁₂₋₁₈ fatty acids are preferably used.

Besides components a) to c) described above, the compositions according to the invention may also contain nonionic surfactants as component d). Nonionic surfactants are well known to the expert and are all suitable for the purposes of the teaching according to the invention.

However, nonionic surfactants from the classes of alkyl (oligo)glycosides, fatty alcohols and/or alkoxylated, preferably ethoxylated, fatty alcohols are particularly preferred. Alkyl and alkenyl oligoglycosides are known nonionic surfactants which correspond to formula (II):

R¹O-[G]ₚ (II)

in which R¹ is an alkyl and/or alkenyl group containing 4 to 22 carbon atoms, G is a sugar unit containing 5 or 6 carbon atoms and p is a number of 1 to 10. They may be obtained by the relevant methods of preparative organic chemistry. The alkyl and/or alkenyl oligoglycosides may be derived from aldoses or ketoses containing 5 or 6 carbon atoms, preferably glucose. Accordingly, the preferred alkyl and/or alkenyl oligoglycosides are alkyl and/or alkenyl oligoglucosides. The index p in general formula (II) indicates the degree of oligomerization (DP), i.e., the distribution of mono- and oligoglycosides, and is a number of 1 to 10. Whereas p in a given compound must always be an integer and, above all, may assume a value of 1 to 6, the value p for a certain alkyl oligoglycoside is an analytically determined calculated quantity which is generally a broken number. Alkyl and/or alkenyl oligoglycosides having an average degree of oligomerization p of 1.1 to 3.0 are preferably used. Alkyl and/or alkenyl oligoglycosides having a degree of oligomerization of less than 1.7 and, more particularly, between 1.2 and 1.4 are preferred from the applicational point of view. The alkyl or alkenyl group R¹ may be derived from primary alcohols containing 4 to 11 and preferably 8 to 10 carbon atoms. Typical examples are butanol, caproic alcohol, caprylic alcohol, capric alcohol and undecyl alcohol and the technical mixtures thereof obtained, for example, in the hydrogenation of technical fatty acid methyl esters or in the hydrogenation of aldehydes from Roelen's oxosynthesis. Alkyl (oligo)glucosides having a chain length of C₈ to C₁₀ (DP=1 to 3), which are obtained as first runnings in the separation of technical C₈₋₁₈ coconut oil fatty alcohol by distillation and which may contain less than 6% by weight of C₁₋₂ alcohol as an impurity, and also alkyl oligoglucosides based on technical C_{9/11} oxoalcohols (DP=1 to 3) are preferred. In addition, the alkyl or alkenyl group R¹ may also be derived from primary alcohols containing 12 to 22 and preferably 12 to 14 carbon atoms. Typical examples are lauryl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol, brassidyl alcohol and technical mixtures thereof which may be obtained as described above. Alkyl oligoglucosides based on hydrogenated C_{12/14} cocoalcohol with a DP of 1 to 3 are preferred.

Besides the APG compounds mentioned above, other preferred nonionic surfactants are alkoxylated fatty alcohols which preferably correspond to formula (III):

R²O(CH₂CH₂O)ₙH (III)

in which R² is a linear or branched alkyl and/or alkenyl group containing 6 to 22 carbon atoms and n is a number of 1 to 50, more particularly a number of 3 to 30 and preferably a number of 3 to 12. Typical examples are adducts of on average 1 to 50, preferably 5 to 40 and more particularly 10 to 25 mol ethylene oxide with, for example, caproic alcohol, caprylic alcohol, 2-ethylhexyl alcohol, capric alcohol, lauryl alcohol, isotridecyl alcohol, myristyl alcohol, cetyl alcohol, palmitolelyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol and brassidyl alcohol and the technical mixtures thereof obtained, for example, in the high-pressure hydrogenation of technical methyl esters based on fats and oils or aldehydes from Roelen's oxo synthesis and as monomer fraction in the dimerization of unsaturated fatty alcohols. Adducts of 10 to 40 mol ethylene oxide with technical C₁₂₋₁₈ fatty alcohols, such as for example coconut oil, palm oil, palm kernel oil or tallow fatty alcohol, are preferred.

Besides the substances described above, any other nonionic, anionic, cationic and/or amphoteric surfactants known to the expert may be present as surfactants. Typical examples of nonionic surfactants are fatty alcohol polyglycol ethers, alkylphenol polyglycol ethers, fatty acid polyglycol esters, fatty acid amide polyglycol ethers, fatty amine polyglycol ethers, alkoxylated triglycerides, mixed ethers and mixed formals, optionally partly oxidized alk(en)yl oligoglycosides or glucuronic acid derivatives, fatty acid-N-alkyl glucamides, protein hydrolyzates (more particularly wheat-based vegetable products), polyol fatty acid esters, sugar esters, sorbitan esters, polysorbates and amine oxides. If the nonionic surfactants contain polyglycol ether chains, the polyglycol ether chains may have a conventional homolog distribution, although they preferably have a narrow homolog distribution.

Typical examples of cationic surfactants are quaternary ammonium compounds and esterquats, more particularly quaternized fatty acid trialkanolamine ester salts. Typical examples of amphoteric or zwitterionic surfactants are alkylbetaines, alkylamidobetaines, aminopropionates, aminoglycinates, imidazolinium betaines and sulfobetaines. The surfactants mentioned are all compounds already known per se.

The compositions according to the invention may contain the various surfactants individually or in the form of mixtures with one another, with the proviso that at least one component a) and one component b) are present.

The compositions according to the invention as described in the foregoing preferably contain:
a) 0.1 to 99% by weight polydiallyl dialkyl ammonium compounds,
b) 1 to 90% by weight anionic surfactants,
c) 0 to 20% by weight soap and
d) 0 to 35% by weight nonionic surfactants.

Other preferred compositions contain 0.1 to 98% by weight polydiallyl dialkyl ammonium compounds, 1 to 90% by weight anionic surfactants, 1 to 20% by weight soap and 0 to 35% by weight nonionic surfactants. The reason for this is that, according to studies conducted by applicants, the combination of components a) and b) and the compulsory presence of soap lead to a particularly clear dye-transfer-inhibiting effect. In another preferred embodiment, the compositions according to the invention have a ratio by weight between components a) and b) of 10:1 to 1:10 and preferably in the range from 1:8 to 1:1. The soap c) and the cationic polymer a) are preferably present in a ratio by weight of 1:1 to 1:5 and preferably in a ratio by weight of 1:1 to 1:3. The teaching according to the invention also allows high percentages of anionic surfactants to be formulated together with the cationic polymers. Accordingly, in a preferred embodiment, compositions containing component b) and component d) in a ratio by weight of 10:1 to 1:10 and preferably in a ratio by weight of 10:1 to 1:1 are formulated Compositions which also contain soap are particularly advantageous.

The present invention also relates to compositions which consist solely of one polymer a) and one anionic surfactant b). Such compositions can be produced in the form of compact granules and used for the production of detergents. Compositions which contain soap in addition to components a) and b) are preferred.

As described above, the compositions according to the invention may advantageously contain alkyl oligoglycosides and/or linear alkoxylated fatty alcohols as an additional component d), i.e., in addition to components a), b) and/or 6). Such compositions preferably contain polydiallyl dimethyl ammonium chloride as component a).

Component a) is present in the compositions according to the invention preferably in quantities of 0.1 to 0.9% by weight, more preferably in quantities of 0.1 to 0.7% by weight and most preferably in quantities of 0.1 to 0.5% by weight. It has been found that the use according to the teaching of the present invention leads to a distinct improvement over the prior art because, according to the present technical teaching, particularly small quantities of cationic polymers are sufficient to produce a satisfactory dye-transfer-inhibiting effect.

The present invention also relates to granular or powder-form compositions containing component a) in quantities of 10 to 30% by weight, component b) in quantities of 90 to 70% by weight and component c) in quantities of 0 to 10% by weight. However, these compositions preferably contain component c) in quantities of 1 to 6% by weight.

The present invention also relates to solid detergents containing surfactants, builders and other typical additives, the detergent containing between 0.05 and 10% by weight of the composition described in the foregoing. Such detergents contain other typical ingredients such as, for example, bleaching agents, bleach activators, detergency boosters, enzymes, enzyme stabilizers, redeposition inhibitors, optical brighteners, soil repellents, foam inhibitors, inorganic salts and perfumes and dyes.

A suitable solid builder is, in particular, finely crystalline zeolite containing synthetic and bound water, such as detergent-quality zeolite NaA. However, zeolite NaX and mixtures of NaA and NaX are also suitable. The zeolite may be used in the form of a spray-dried powder or even as an undried stabilized suspension still moist from its production. Where the zeolite is used in the form of a suspension, the suspension may contain small additions of nonionic surfactants as stabilizers, for example 1 to 3% by weight—based on zeolite—of ethoxylated C₁₂₋₁₈ fatty alcohols containing 2 to 5 ethylene oxide groups or ethoxylated isotridecanols. Suitable zeolites have a mean particle size of less than 10 μm (volume distribution, as measured by the Coulter Counter Method) and contain preferably 18 to 22% by weight and more preferably 20 to 22% by weight of bound water. Suitable substitutes or partial substitutes for zeolites are crystalline layer-form sodium silicates with the general formula NaMSiₓO₂ₓ₊₁.yH₂O, where M is sodium or hydrogen, x is a number of 1.9 to 4 and y is a number of 0 to 20, preferred values for x being 2, 3 or 4. Preferred crystalline layer silicates are those in which M in the general formula stands for sodium and x assumes the value 2 or 3. Both β- and β-sodium disilicates Na₂Si₂O₅.yH₂O are particularly preferred. The solid detergents according to the invention preferably contain 10 to 60% by weight of zeolite and/or crystalline layer silicates as solid builders, mixtures of zeolite and crystalline layer silicates in any ratio being particularly advantageous. In one particularly preferred embodiment, the detergents contain 20 to 50% by weight of zeolite and/or crystalline layer silicates. Particularly preferred detergents contain up to 40% by weight of zeolite and, more particularly, up to 35% by weight of zeolite, based on water-free active substance. Other suitable ingredients of the detergents are water-soluble amorphous silicates which are preferably used in combination with zeolite and/or crystalline layer silicates. Particularly preferred detergents are those which contain above all sodium silicate with a molar ratio of Na₂O to SiO₂ (modulus) of 1:1 to 1:4.5 and preferably 1:2 to 1:3.5. The amorphous sodium silicate content of the detergents is preferably up to 15% by weight and more preferably from 2 to 8% by weight. Phosphates, such as tripolyphosphates, pyrophosphates and orthophosphates, may also be present in the detergents in small quantities. The phosphate content of the detergents is preferably up to 15% by weight and, more particularly, from 0 to 10% by weight. In addition, the detergents may contain layer silicates of natural and synthetic origin. Useful organic builders are, for example, the polycarboxylic acids preferably used in the form of their sodium salts, such as citric acid, adipic acidic acid, succinic acid, glutaric acid, tartaric acid, sugar acids, aminocarboxylic acids, nitrilotriacetic acid (NTA), providing their use is not ecologically unsafe, and mixtures thereof. Preferred salts are the salts of polycarboxylic acids, such as citric acid, adipic acid, succinic acid, glutaric acid, tartaric acid, sugar acids and mixtures thereof. Suitable polymeric polycarboxylates are, for example, the sodium salts of polyacrylic acid or polymethacrylic acid, for example those with a relative molecular weight of 800 to 150,000 (based on acid). Suitable copolymeric polycarboxylates are, in particular, those of acrylic acid with methacrylic acid and acrylic acid or methacrylic acid with maleic acid. Copolymers of acrylic acid with maleic acid which contain 50 to 90% by weight of acrylic acid and 50 to 10% by weight of maleic acid are particularly suitable. Their relative molecular weight, based on free acids, is generally in the range from 5,000 to 200,000, preferably in the range from 10,000 to 120,000 and more preferably in the range from 50,000 to 100,000. It is not absolutely essential to use polymeric polycarboxylates. However, if polymeric polycarboxylates are used, detergents containing biodegradable polymers, for example terpolymers which contain acrylic acid and maleic acid or salts thereof and vinyl alcohol or vinyl alcohol derivatives as monomers or acrylic acid and 2-alkyl allyl sulfonic acid or salts thereof and sugar derivatives as monomers are preferred. Other suitable builders are polyacetals which may be obtained by reacting dialdehydes with polyol carboxylic acids containing 5 to 7 carbon atoms and at least 3 hydroxyl groups.

Among the compounds yielding hydrogen peroxide in water which are used as bleaching agents, sodium perborate tetrahydrate and sodium perborate monohydrate are particularly important. Other suitable bleaching agents are, for example, peroxycarbonate, citrate perhydrates and salts of peracids, such as perbenzoates, peroxyphthalates or diperoxydodecanedioic acid. They are normally used in quantities of 8 to 25% by weight. Sodium perborate monohydrate is preferred and is used in quantities of 10 to 20% by weight and preferably in quantities of 10 to 15% by weight. By virtue of its ability to bind free water to form the tetrahydrate, it contributes towards increasing the stability of the detergent.

In order to obtain an improved bleaching effect where washing is carried out at temperatures of 60° C. or lower, bleach activators may be incorporated in the preparations. Examples of bleach activators are N-acyl and O-acyl compounds which form organic peracids with hydrogen peroxide, preferably N,N′-tetraacylated diamines, also carboxylic anhydrides and esters of polyols, such as glucose pentaacetate. The bleach activator content of bleach-containing detergents is in the usual range, i.e., preferably between 1 and 10% by weight and more preferably between 3 and 8% by weight. Particularly preferred bleach activators are N,N,N′,N′-tetraacetyl ethylenediamine and 1,5-diacetyl-2,4-dioxohexahydro-1,3,5-triazine.

Suitable enzymes are those from the class of proteases, lipases, amylases, cellulases and mixtures thereof. Enzymes obtained from bacterial strains or fungi, such as Bacillus subtilis, Bacillus licheniformis and Streptomyces griseus, are particularly suitable. Proteases of the subtilisin type are preferably used, proteases obtained from Bacillus lentus being particularly preferred. They may be used in quantities of about 0.2 to about 2% by weight. The enzymes may be adsorbed onto supports and/or encapsulated in membrane materials to protect them against premature decomposition. In addition to the monohydric and polyhydric alcohols and the phosphonates, the detergents may contain other enzyme stabilizers. For example, 0.5 to 1% by weight of sodium formate may be used. It is also possible to use proteases which are stabilized with soluble calcium salts and which have a calcium content of preferably about 1.2% by weight, based on the enzyme. However, it is of particular advantage to use boron compounds, for example boric acid, boron oxide, borax and other alkali metal borates, such as the salts of orthoboric acid (H₃BO₃), metaboric acid (HBO₂) and pyroboric acid (tetraboric acid H₂B₄O₇).

The function of redeposition inhibitors is to keep the soil detached from the fibers suspended in the wash liquor and thus to prevent discoloration. Suitable redeposition inhibitors are water-soluble, generally organic colloids, for example the water-soluble salts of polymeric carboxylic acids, glue, gelatin, salts of ether carboxylic acids or ether sulfonic acids of starch or cellulose or salts of acidic sulfuric acid esters of cellulose or starch. Water-soluble polyamides containing acidic groups are also suitable for this purpose. Soluble starch preparations and other starch products than those mentioned above, for example degraded starch, aldehyde starches, etc., may also be used. Polyvinyl pyrrolidone is also suitable. However, cellulose ethers, such as carboxymethyl cellulose, methyl cellulose, hydroxyalkyl cellulose, and mixed ethers, such as methyl hydroxyethyl cellulose, methyl hydroxypropyl cellulose, methyl carboxymethyl cellulose and mixtures thereof, and polyvinyl pyrrolidone are preferably used, for example in quantities of 0.1 to 5% by weight, based on the detergent.

The detergents may contain derivatives of diaminostilbene disulfonic acid or alkali metal salts thereof as optical brighteners. Suitable optical brighteners are, for example, salts of 4,4′-bis-(2-anilino-4-morpholino-1,3,5-triazinyl-6-amino)-stilbene-2,2′-disulfonic acid or compounds of similar structure which, instead of the morpholino group, contain a diethanolamino group, a methylamino group, an anilino group or a 2-methoxyethylamino group. Brighteners of the substituted diphenyl styryl type, for example alkali metal salts of 4,4′-bis-(2-sulfostyryl)-diphenyl, 4,4′-bis-(4-chloro-3-sulfostyryl)-diphenyl or 4-(4-chlorostyryl)-4′-(2-sulfostyryl)-diphenyl, may also be present. Mixtures of the brighteners mentioned above may also be used. Uniformly white granules are obtained if, in addition to the usual brighteners in the usual quantities, for example between 0.1 and 0.5% by weight and preferably between 0.1 and 0.3% by weight, the detergents also contain small quantities, for example 10⁻⁶ to 10⁻³% by weight and preferably around 10⁻⁵% by weight, of a blue dye.

Suitable soil repellents are substances which preferably contain ethylene terephthalate and/or polyethylene glycol terephthalate groups, the molar ratio of ethylene terephthalate to polyethylene glycol terephthalate being in the range from 50:50 to 90:10. The molecular weight of the linking polyethylene glycol units is more particularly in the range from 750 to 5,000, i.e., the degree of ethoxylation of the polymers containing polyethylene glycol groups may be about 15 to 100. The polymers are distinguished by an average molecular weight of about 5,000 to 200,000 and may have a block structure, but preferably have a random structure. Preferred polymers are those with molar ratios of ethylene terephthalate: polyethylene glycol terephthalate of about 65:35 to about 90:10 and preferably in the range from about 70:30 to 80:20. Other preferred polymers are those which contain linking polyethylene glycol units with a molecular weight of 750 to 5,000 and preferably in the range from 1,000 to about 3,000 and which have a molecular weight of the polymer of about 10,000 to about 50,000. Examples of commercially available polymers are the products MILEASE® T (ICI) or REPELOTEX® SRP 3 (Rhone-Poulenc).

Where the detergents are used in washing machines, it can be of advantage to add typical foam inhibitors to them. Suitable foam inhibitors are, for example, soaps of natural or synthetic origin which have a high percentage content of C₁₈₋₂₄ fatty acids. Suitable non-surface-active foam inhibitors are, for example, organopolysiloxanes and mixtures thereof with microfine, optionally silanized, silica and also paraffins, waxes, microcrystalline waxes and mixtures thereof with silanized silica or bis-stearyl ethylenediamide. Mixtures of different foam inhibitors, for example mixtures of silicones, paraffins and waxes, may also be used with advantage. The foam inhibitors, more particularly silicone- and/or paraffin-containing foam inhibitors, are preferably fixed to a granular water-soluble or water-dispersible support. Mixtures of paraffins and bis-stearyl ethylenediamides are particularly preferred.

The detergents according to the invention may be produced by any of the known processes, such as mixing, spray drying, granulation and extrusion. Processes in which several components, for example spray-dried components and granulated and/or extruded components, are mixed with one another are particularly suitable. Such processes are particularly suitable for processing and producing the solid compositions according to the invention. Spray-dried or granulated components may even be subsequently treated, for example with nonionic surfactants, more particularly ethoxylated fatty alcohols, by the usual methods. In a preferred embodiment, the cationic polymer is dissolved in water and the resulting solution is then sprayed onto the anionic surfactant component.

In granulation and extrusion processes in particular, the anionic surfactants optionally present in the form of a spray-dried, granulated or extruded compound are preferably used either as a mixing component in the process or subsequently as an additive to other granules.

It is also possible and, depending on the formulation, can be of advantage subsequently to add other individual constituents of the composition, for example citrate or citric acid or other polycarboxylates or polycarboxylic acids, polymeric carboxylates, zeolite and/or layer silicates, which may optionally be crystalline, to spray-dried, granulated and/or extruded components optionally treated with nonionic surfactants and/or other ingredients that are liquid to wax-like at the processing temperature. In a preferred process, the surface of components of the composition or the composition as a whole is subsequently treated to reduce the tackiness of the granules rich in nonionic surfactants and/or to improve their solubility. Suitable surface modifiers are known from the prior art. Besides other suitable surface modifiers, fine-particle zeolites, silicas, amorphous silicates, fatty acids or fatty acid salts, for example calcium stearate, but especially mixtures of zeolite and silicas or zeolite and calcium stearate are particularly preferred.

### EXAMPLES

### Example 1

Two solid detergents (see Table 1) were formulated, a granular compound according to the invention consisting of 20% by weight polydiallyl dimethyl ammonium chloride and 80% by weight alkyl sulfate being added in formulation 2. The following ingredients were used:
DEHYDOL LT7 C₁₂₋₁₈ fatty alcohols, ethoxylated (7 EO) (Cognis)
DEHYDRAN 770 paraffin defoamer(Cognis)
DEQUEST 2066 diethylenetriamine pentamethylenephosphonic acid, sodium salt (Solutia)
PORTIL N soda waterglass (Cognis)
SOKOLAN CP 5 G maleic acid/acrylic acid copolymer, sodium salt (BASF)
SULFOPON 1214 G C₁₂₋₁₄ fatty alcohol sodium salt
UFARYL DL 90 C dodecyl benzenesulfonic acid, sodium salt (Unger)
WESSALITH 4000 zeolite 4A (Degussa)

All quantities in the Tables are expressed as % by weight active substance.

TABLE 1

| | Formulation 1 | Formulation 2 |
|---|---|---|
| WESSALITH 4000 | 25.0 | 25.0 |
| Soda | 15.0 | 15.0 |
| PORTILI N | 3.0 | 3.0 |
| SOKALAN CP 5 G | 3.0 | 3.0 |
| UFARYL DL 90 C | 4.5 | 4.5 |
| DEHYDOL LT 7 | 6.5 | 6.5 |
| DEQUEST 2066 | 1.0 | 1.0 |
| Water | 10.0 | 10.0 |
| Soap¹⁾ | 1.5 | 1.5 |
| SULFOPON 1214 G | — | 2.0 |
| Granular compound | 2.5 | — |
| Na sulfate | to 100 | to 100 |
| DEHYDRAN 770 | 0.75 | 0.75 |

¹⁾C₁₀₋₁₈ fatty acid, potassium salt

To test dye transfer, 0.34 g detergent 1 and 0.34 g detergent 2 was added to 68 ml of a dye solution (containing 0.0045 g/l Doramin Blau 200). This corresponds to a detergent concentration of 5 g/l in the test solution. The test solution was heated to 40° C. Cotton test specimens measuring 6×2.5 cm (test fabric WFK 10A) were then added to each test solution. The color of the test specimens was measured beforehand with a Minolta CR 200 Chromameter in laboratory mode. The test specimens remained in the wash liquor for 1 h at 40° C. with gentle stirring. The test specimens were then separated from the wash liquor and rinsed for 2 mins. with tap water. After mangling, the color of the test specimens was measured with the Minolta CR 200 Chromameter in laboratory mode. A color difference was calculated from the starting and end values of the measurements. The smaller the figure, the better the inhibition of dye transfer.

Formulation 2 without the compound according to the invention produced a color difference of 34. By contrast, formulation 1 according to the invention produced a distinctly better color difference of 26.

### Example 2

A series of tests was conducted with solid detergents containing different quantities of cationic polymer, anionic surfactant and nonionic surfactants. The formulations can be found in Table 2 and the results of the dye transfer measurements in Graphic 1.

TABLE 2

| % AS | 1 | 2 | 3 | 4 | 5 | 6 | 7 | 8 | 9 |
|---|---|---|---|---|---|---|---|---|---|
| WESSALITH 4000 | 25.0 | 25.0 | 25.0 | 25.0 | 25.0 | 25.0 | 25.0 | 25.0 | 25.0 |
| Soda | 15.0 | 15.0 | 15.0 | 15.0 | 15.0 | 15.0 | 15.0 | 15.0 | 15.0 |
| PORTIL N | 3.0 | 3.0 | 3.0 | 3.0 | 3.0 | 3.0 | 3.0 | 3.0 | 3.0 |
| SOKALAN CP 5 G | 3.0 | 3.0 | 3.0 | 3.0 | 3.0 | 3.0 | 3.0 | 3.0 | 3.0 |
| UFARYL DL 90 C | 0.0 | 0.0 | 1.6 | 3.2 | 4.8 | 6.5 | 8.1 | 9.7 | 13.0 |
| DEHYDOL LT 7 | 14.5 | 13.0 | 11.4 | 9.8 | 8.2 | 6.5 | 4.9 | 3.3 | 0.0 |
| DEQUEST 2066 | 1.0 | 10 | 1.0 | 1.0 | 1.0 | 1.0 | 1.0 | 1.0 | 1.0 |
| Water | 10.0 | 10.0 | 10.0 | 10.0 | 10.0 | 10.0 | 10.0 | 10.0 | 10.0 |
| Soap | 0.0 | 1.5 | 1.5 | 1.5 | 1.5 | 1.5 | 1.5 | 1.5 | 1.5 |
| Polymer | 0-0.5 | 0-0.5 | 0-0.5 | 0-0.5 | 0-0.5 | 0-0.5 | 0-0.5 | 0-0.5 | 0-0.5 |
| Na-Sulfate | 28.0 | 28.0 | 28.0 | 28.0 | 28.0 | 28.0 | 28.0 | 28.0 | 28.0 |

It can be seen from Graphic 1 that the addition of the polymer produces a distinct improvement in the color difference. It is clear that, where relatively large quantities of cationic polymer are added, relatively large quantities of anionic surfactants also can be formulated in the compound. In the present case, anionic and nonionic surfactants Can be formulated in a ratio by weight of 1:1, providing 0.5% by weight of the cationic polymer is present.

What is claimed is:

1-16. (canceled)

17. A solid composition, comprising:
(a) 0.1 to 99% by weight of a cationic polymer having dye-transfer-inhibiting and/or dye-fixing properties; and
(b) 99.9 to 1% by weight of an anionic surfactant.

18. The solid composition according to claim 17, wherein component (a) is selected from the group consisting of polydiallyl dialkyl ammonium compounds, derivatives thereof, and mixtures thereof.

19. The solid composition according to claim 17, wherein component (b) is selected from the group consisting of: linear alkyl benzene sulfonates, alkyl ether sulfates, alkyl sulfates, secondary alkane sulfonates, and mixtures thereof.

20. The solid composition according to claim 17, further comprising, as component (c), nonionic surfactants and/or soaps.

21. A composition, comprising:
(a) 0.1 to 99% by weight polydiallyl dialkyl ammonium compounds;
(b) 1 to 90% by weight anionic surfactants;
(c) 0 to 20% by weight soap; and
(d) 0 to 35% by weight nonionic surfactants.

22. The composition according to claim 21, comprising:
(a) 0.1 to 98% by weight polydiallyl dialkyl ammonium compounds;
(b) 1 to 90% by weight anionic surfactants;
(c) 1 to 20% by weight soap; and
(d) 0 to 35% by weight nonionic surfactants.

23. The solid composition according to claim 17, wherein the ratio by weight of component (a) to component (b) is in the range from 10:1 to 1:10.

24. The solid composition according to claim 17, wherein the ratio by weight of component (a) to component (b) is in the range of from 1:8 to 1:1.

25. The solid composition according to claim 20, wherein component (c) comprises a soap, and component (c) and component (a) are present in a ratio by weight of 1:1 to 1:5.

26. The solid composition according to claim 20, wherein component (c) comprises a soap, and component (c) and component (a) are present in a ratio by weight of 1:2 to 1:3.

27. The solid composition according to claim 17, consisting of component (a) and component (b).

28. The solid composition according to claim 20, consisting of component (a), component (b), and a soap as component (c).

29. The composition according to claim 21, wherein component (a) is polydiallyl dimethyl ammonium chloride and component (d) is selected from the group consisting of one or more alkyl (oligo)glycosides, one or more linear alkoxylated fatty alcohols, and mixtures thereof.

30. The solid composition according to claim 17, in the form of a granule or a powder.

31. The solid composition according to claim 17, wherein component (a) is present in an amount of from about 0.1 to 0.9% by weight.

32. The solid composition according to claim 17, wherein component (a) is present in an amount of from about 0.1 to 0.7% by weight.

33. The solid composition according to claim 17, wherein component (a) is present in an amount of from about 0.1 to 0.5% by weight.

34. The solid composition according to claim 20, wherein component (a) is present in an amount of 10 to 30% by weight, component (b) is present in an amount of 90 to 70% by weight, and component (c) is present in an amount of from 0 to 10% by weight, and wherein the solid composition is in the form of a granule or powder.

35. A method for the preparation of solid detergents, comprising:
combining 0.1 to 99% by weight of a cationic polymer having dye-transfer-inhibiting and/or dye-fixing properties and 99.9 to 1% by weight of an anionic surfactant; and
adding to a detergent.

36. The solid composition according to claim 17, incorporated into a detergent, wherein the amount of the composition present is 0.05 to 10% by weight of the detergent.

37. The solid composition according to claim 17, incorporated into a detergent, wherein the amount of the composition present is 0.1 to 2.5% by weight of the detergent.

38. The solid composition according to claim 17, incorporated into a detergent, wherein the amount of the composition present is 0.1 to 0.9% by weight of the detergent.
